(19) United States
(12) Patent Application Publication
(10) Pub. No.: US 2007/0204241 A1
(43) Pub. Date: Aug. 30, 2007

(54) Method for generating three dimensional stair objects in computer aided design drawings

(75) Inventors: William Glennie, Bradford, NH (US); Gamal Kira, Mehlbach (DE); William Fitzpatrick, New Boston, NH (US)

Correspondence Address: PATTERSON & SHERIDAN, L.L.P., 3040 POST OAK BOULEVARD, SUITE 1500, HOUSTON, TX, 77056, US

(73) Assignee: Autodesk, Inc.

(21) Appl. No.: 11/363,657

(22) Filed: Feb. 28, 2006

(51) Int. Cl. G06F 3/048

(52) U.S. Cl. 715/964; 715/900; 715/961

(57) ABSTRACT

Embodiments of the invention provide a method for generating a three dimensional representation of a staircase in a computer aided design drawing. Generally, embodiments of the invention allow a user to create a three dimensional stair object with an arbitrary tread shape and with an arbitrary overlap between any two adjacent treads. A user creates or specifies line work elements in a two dimensional plan view to represent aspects the desired staircase, and a computer aided design application generates a three dimensional stair object from this information. Once generated, a three dimensional stair object may be manipulated using a variety of user selectable grips, simplifying both the design process and work required to modify a three dimensional stair object included in a CAD drawing.

### BACKGROUND OF THE INVENTION

1. Field of the Invention

The present invention generally relates to computer software. More specifically, the present invention relates to a computer aided design (CAD) application configured to generate three dimensional (3D) stair objects in a CAD drawing.

2. Description of the Related Art

The term computer-aided design (CAD) generally refers to a broad variety of computer-based tools used by architects, engineers, and other construction and design professionals. CAD applications may be used to construct computer models representing virtually any real-world construct. Commonly, CAD applications are used to compose computer models and drawings related to construction projects. For example, a CAD application may be used to compose a 3D model of a house or an office building. Once composed, these CAD models are often used to generate a variety of two-dimensional (2D) and 3D views such as plan, profile, section, and elevation views. Additionally, such models may be used to generate, architectural, construction, engineering, and other documentation related to the construction project. Increasingly, CAD models are used to generate and display realistic 3D renderings of an object being modeled.

A common feature of CAD drawings of an architectural plan is a staircase object. In a 2D drawing, staircases are often represented using a set of hand-drawn polygons to represent a step (or tread) and an arrow representing a direction up, or down, for the stair. Creating realistic 3D renderings of a staircase, however, has proven to be more difficult. Currently two approaches are commonly used to model a 3D stair object in a CAD drawing. First, a user may compose a drawing by hand, drawing each individual tread and riser as an independent 3D object in a drawing. One drawback to this approach is that it often requires a great deal of time because the user has to calculate and draw all stair elements in plan, section and elevation using drawing primitives. Moreover, if the user desires to modify a hand drawn stair (e.g., to add a tread or to change the height, length, or shape), the modifications must also be made to each affected object individually. For example, changing the height of a staircase may require the user to redraw each riser to increase the height thereof, and to realign each tread to the appropriate risers. While this works as intended, it often becomes both tedious and error prone.

A second approach includes the use of stair object generations routines provided by a CAD application. These routines typically require that the user specify the number of treads and the total stair height. Each tread of the 3D stair object is generated using a defined shape and positioned relative to one another. Typically, the leading edge of a lower tread is required to run parallel with the riser connecting it to an adjacent tread, and the CAD application automates the process by generating and aligning one tread after another. While this has allowed users to generate a 3D stair object for a simple staircase (e.g., a straight staircase with identical, rectangular treads, it fails to allow users to generate a 3D stair object with an arbitrary tread shape or with an arbitrary overlap between any two adjacent treads. For these types of stairs, the user must revert to drawing elements of the staircase by hand from drawing primitives, as previously described.

Accordingly, there remains a need in the art for a technique for generating 3D stair objects in CAD drawings that does not rely on the user having to manually compose each element of the desired 3D stair object, and that allows users to easily create and modify 3D stairs objects with arbitrary tread shapes and with arbitrary overlap between adjacent treads.

### SUMMARY OF THE INVENTION

Embodiments of the invention provide a method for generating a 3D representation of a staircase in a CAD drawing. Generally, the method includes receiving a selection of 2D line work in the CAD drawing. The 2D line work may include a selection of a path and a plurality of tread profiles. Each tread profile may specify the shape of an individual tread in the 3D stair object to be generated, and each tread profile may be positioned along the path to indicate the relative position of treads in the 3D stair object to be generated.

The method further includes identifying a selection of attributes for the 3D stair object to be generated. For example, a CAD application may be configured to prompt the user to identify aspects of the desired stair object such as a carriage type, a direction, a height, a nosing, and/or length attributes for the 3D stair object to be generated. Once the CAD application receives the selection of 2D line work and the selection of attributes for the 3D stair object to be generated, the CAD application may be configured to generate a 3D stair object from this information and to display the representation of the 3D stair object in the CAD drawing.

Advantageously, embodiments of the present invention allow users to compose a CAD drawing that includes irregularly shaped staircases, custom shaped treads, and combinations of these. As stairs with features such as these commonly occur in real-world construction, embodiments of the invention increase the usefulness of a CAD application by allowing users to easily represent many different stair geometries in a CAD drawing. Further, once generated, a 3D stair object may be manipulated using a variety of user selectable grips, simplifying both the design process and work required to modify a 3D stair object included in a CAD drawing.

### BRIEF DESCRIPTION OF THE DRAWINGS

FIG. 1 is a block diagram illustrating a system used to compose a CAD drawing, according to one embodiment of the invention.

FIG. 2 illustrates a graphical user interface screen displaying a set of 2D line work used to generate a 3D stair object, according to one embodiment of the invention.

FIG. 3 illustrates a 3D stair object generated from the 2D line work illustrated in FIG. 2, according to one embodiment of the invention.

FIG. 4 illustrates a method for generating a 3D stair object in a CAD drawing, according to one embodiment of the invention.

FIGS. 5A-5C illustrate a 3D stair object generated from 2D line work manipulated using a selectable grip, according to one embodiment of the invention.

FIG. 6 illustrates a tread of a 3D stair object manipulated using a selectable grip, according to one embodiment of the invention.

### DETAILED DESCRIPTION OF THE PREFERRED EMBODIMENTS

Embodiments of the invention provide a method for generating a three dimensional (3D) representation of a staircase in a computer aided design (CAD) drawing. Generally, embodiments of the invention allow a user to create 3D stair objects with an arbitrary tread shape and with an arbitrary overlap between any two adjacent treads. Further, embodiments of the invention allow users to design a staircase using a simple yet flexible workflow. First, a user creates or specifies elements of a two dimensional (2D) plan view representing aspects of the desired staircase, and a CAD application generates a three dimensional stair object from this information. Once generated, a 3D stair object may be manipulated using a variety of user selectable grips, simplifying both the design process and work required to modify a 3D stair object included in a CAD drawing.

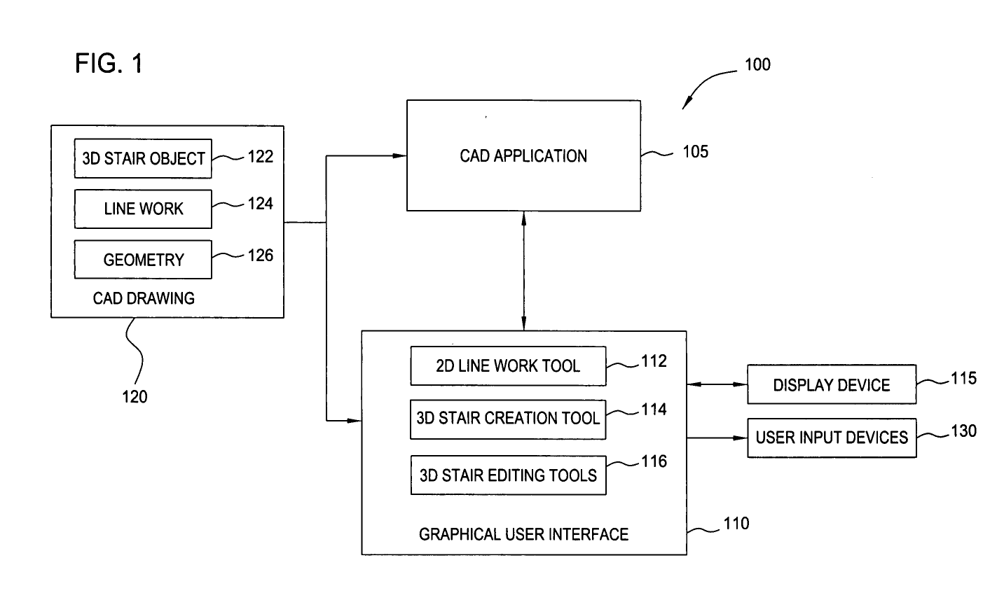

FIG. 1 is a block diagram illustrating a system 100 used to compose a CAD drawing 120, according to one embodiment of the invention. In one embodiment, the components illustrated in system 100 include computer software applications executing on existing computer systems, e.g., desktop computers, server computers, laptop computers, tablet computers, and the like. The software applications described herein, however, are not limited to any particular computing system and may be adapted to take advantage of new computing systems as they become available.

Additionally, the components illustrated in system 100 may be software applications executing on distributed systems communicating over computer networks including local area networks or large, wide area networks, such as the Internet. For example, a graphical user interface 110 may include a software program executing on a client computer system communicating with a CAD application 105. Also, in one embodiment, CAD application 105 and graphical user interface 110 may be provided as an application program (or programs) stored on computer readable media such as a CD-ROM, DVD-ROM, flash memory module, or other tangible storage media.

As shown, the CAD system 100 includes, without limitation, CAD application 105, graphical user interface 110, a CAD drawing 120, user input devices 130, and a display device 115. In one embodiment, CAD application 105 is a software application configured to allow a user interacting with GUI interface 110 to generate a CAD drawing 120. Accordingly, CAD application 105 includes routines or instructions that allow users to create, edit, and save CAD drawing 120. Preferably, the Architectural Desktop application program and associated utilities available from Autodesk®, Inc. may be used.

Graphical user interface 110 provides tools used in creating a 3D stair object. As shown, graphical user interface 110 includes 2D line work tools 112, 3D stair creation tool 114, and 3D stair editing tools 116 used to create a 3D stair object. Those skilled in the art will recognize, however, that the tools of GUI interface 110 shown in FIG. 1 are simplified to highlight aspects of the present invention and that a typical CAD application 105 and GUI interface 110 may include a broad variety of additional tools and features used to compose a CAD drawing 120.

Users interact with GUI interface 110 and tools 112, 114, and 116 to generate a 3D stair object. Data related to a 3D stair object may be stored in CAD drawing 120. Illustratively, CAD drawing 120 includes a 3D stair object 122 that may be generated from 2D line work 124 and geometry data 126.

2D line work tools 112 allow the user to define 2D shapes, such as points, lines, and curves stored in CAD drawing 120 as 2D line work 124. 3D stair creation tool 114 provides a graphical user interface element that allows a user to invoke a 3D stair creation process. As described in greater detail herein, CAD application 105 may be configured to generate a 3D stair object from 2D line work 124 included in CAD drawing 120. Geometry data 126 is used to store the position of 3D stair object 122 relative to other drawing objects included in CAD drawing 120. For example, Geometry data 126 may specify a 3D coordinate location within a space represented by CAD drawing 120.

Typically, user input devices 145 include a mouse pointing device and a keyboard, and display device 115 is a CRT monitor or LCD display.

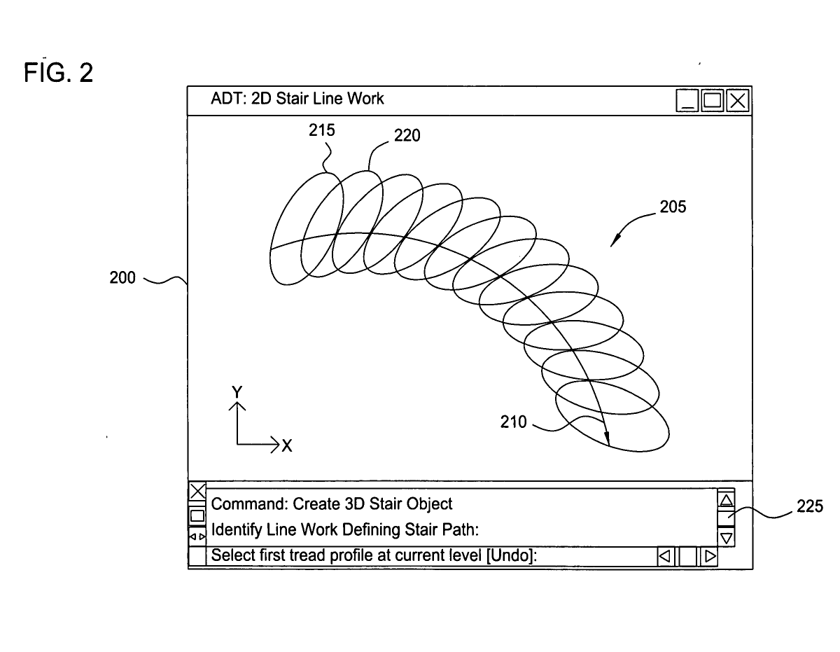

FIG. 2 illustrates a graphical user interface screen displaying a collection of 2D line work 205 that may be used to generate a 3D stair object, according to one embodiment of the invention. As shown, view area 200 displays 2D line work 205. Illustratively, 2D line work 205 includes a path 210 and a plurality of tread profiles (e.g. tread profiles 215 and 220). In this example, CAD application 105 may use path 210 to generate a 3D stair object with a curved shape following path 210 that includes twelve treads, each with a similar oval shape.

In one embodiment, the path 210 represents the general plan geometry of the desired 3D staircase and each tread profile represents the general plan geometry of a tread in the desired 3D stair object. Additionally, the arrow at one end of path 210 is used to indicate the upward direction of the desired 3D stair object. Thus, 2D line work 205 shows tread profile 215 represents a first stair of the desired staircase at a position adjacent and below tread profile 220.

FIG. 2 also shows interface area 225 used to enter commands, such as invoking 2D line work tools 112 to create lines, circles, or other 2D shapes in CAD drawing 120. In one embodiment, 3D stair creation tool 114 may be invoked from a command line interface, like to the one shown in FIG. 2. In this example, the user has entered the command “create 3D stair object” to invoke 3D stair creation tool 114. In response, the CAD application 105 may be configured to provide a sequence of prompts allowing the user to specify which elements of 2D line work 205 to use as the path and tread profiles to use in generating 3D stair object 122, as well as specifying additional aspects of the desired 3D stair object.

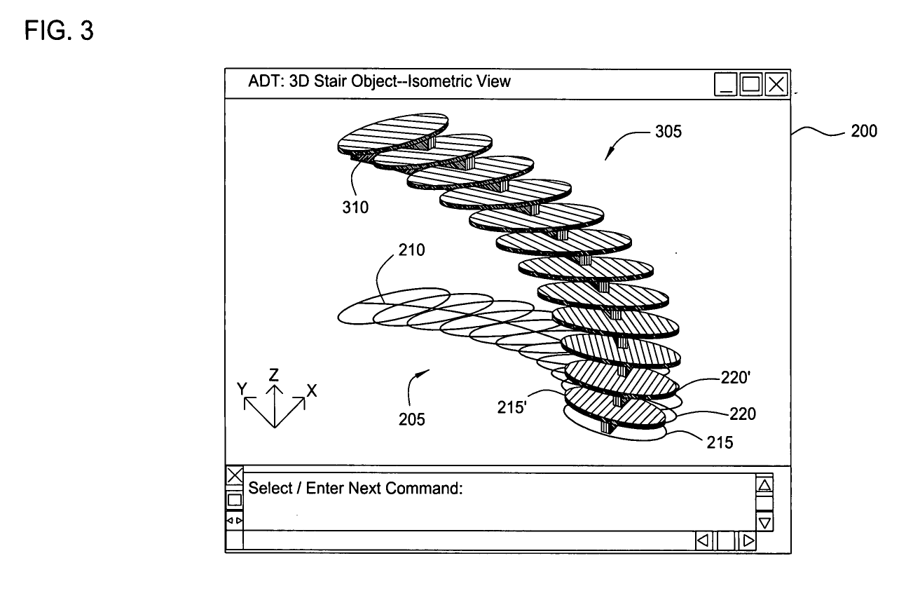

Once the user specifies aspects of the desired 3D stair object, CAD application 105 may be configured to generate a 3D stair object from the specified information. For example, FIG. 3 illustrates a graphical user interface screen displaying a 3D stair object 305 generated from 2D line work 205 according to one embodiment of the invention. Illustratively, the view area 200 has transitioned to a 3D view after the user has invoked 3D stair creation tool 114 and the CAD application 105 has generated 3D stair object 305. As shown, 3D stair object 305 includes a tread corresponding to the tread profiles of 2D line work 205. For example, treads 215′ and 220′ in 3D stair object 305 correspond to tread profiles 215 and 220 in the 2D line work 205. Additionally, the general geometry of 3D stair object 305 follows the curve specified by path 210. In this example, the treads of 3D stair object 305 are supported by carriage 310. In one embodiment, users may specify stair attributes such as tread height, nosing, stair elevation, carriage type, etc, in response to prompts provided by 3D stair creation tool 114. The carriage 310 provides a structure to “carry” each of the tread profiles, and provides a riser to separate adjacent treads from one another.

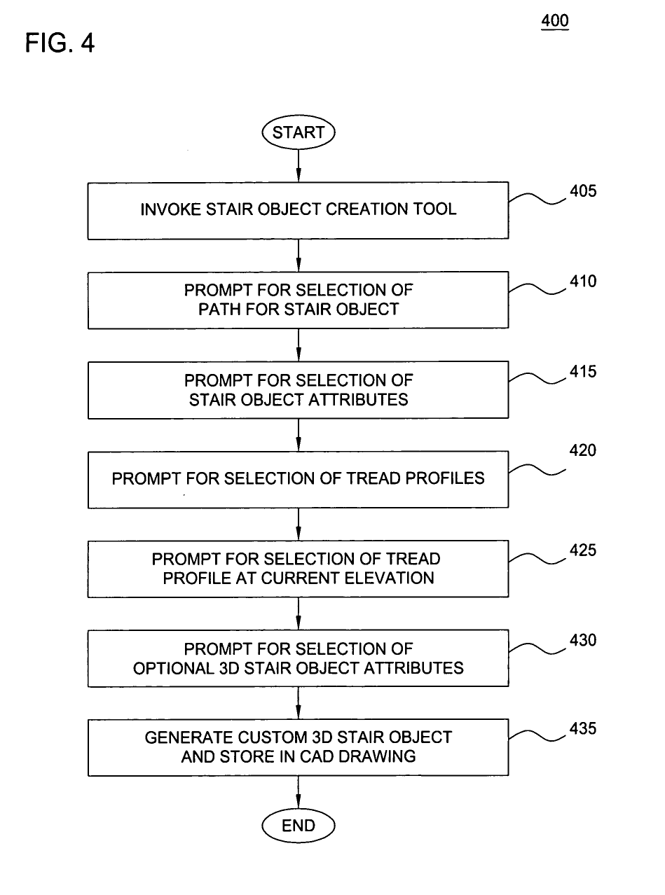

FIG. 4 illustrates a method 400 for generating a 3D stair object in a CAD drawing, according to one embodiment of the invention. Persons skilled in the art will understand that any system configured to perform the method shown in FIG. 4, in any order, is within the scope of the present invention.

In one embodiment, the method 400 begins at step 405 where the user invokes a 3D stair object creation tool 114. For example, the screen shot shown in FIG. 2 illustrates a command interface area 225 where a user may enter command to initiate the 3D stair object creation process. In other embodiments, other interface elements such as a menu item or on-screen button provided as part of GUI interface 110 may be used. Steps 410-430 represent a sequence of prompts presented to a user that allow the CAD application to collect the information used to generate a 3D stair object. The prompts may be managed by 3D stair creation tool 114.

At step 410, the user may be prompted to identify 2D line work to use as the path of the desired 3D stair object. For example, the user may create a path using 2D line work tools 112. Alternatively, if the 2D line work is already present in CAD drawing 120, then the user may identity the desired segments to use in creating the 3D stair object. This latter situation may occur when creating a 3D stair object from line work included in a plan view of a CAD drawing, such as plan view of a floor of an architectural drawing.

At step 415, the user may be prompted to identify a type and location of stair carriage and riser types to use in generating 3D stair object. For example, FIG. 3 shows carriage 310 located directly along path 210. Alternatively, the CAD application may allow the user to specify other configurations such as a left and right carriage located at the left and right side of the treads, or a solid carriage running the length of each tread. Additionally, attributes such as tread width or type may be specified. In one embodiment, attributes of different 3D stair objects may be represented using a style. As is known, a style may be used to represent a collection of individual attributes related to an element in CAD drawing 120. For example, a 3D stair object style may specify a carriage type, riser type, and tread thickness to use in generating a 3D stair object. CAD application 105 may provide a variety of different carriage and riser types and styles.

At step 420, the user may be prompted to identify the tread profiles to use in generating the desired 3D stair object. Like the selection of 2D line work used to specify the path of the desired 3D stair object, the user may create the tread profiles using 2D line work tools 112 or may select elements of 2D line work that already exists in CAD drawing 120. Additionally, the 3D stair creation tool 114 may require that each tread profile define an enclosed shape and that each tread profile intersect the path selected at step 410. These requirements may allow CAD application 150 to generate a realistic 3D stair object from the 2D line work elements selected by the user. Additionally, depending on the stair attributes selected by a user, the CAD application 105 may require that each tread profile intersect with at least one additional tread profile. For example, if a user specifies a stair type where the treads include a “nosing” (a nosing is a common stairway feature where the leading edge of a tread extends beyond a riser for a specified distance) the geometry of the nosing may be determined from the intersection of two adjacent treads.

At step 425, the user may be prompted to identify an up or down direction of the desired 3D stair object. This may occur based on the user specifying a direction to the path specified at step 410. Alternatively, if the 3D stair object is being generated from a plan view of a floor of an architectural drawing, the user may be prompted to identify which tread profile is located at the elevation of the current floor in the plan. Once specified, other tread profiles may be used to generate a 3D stair object extending to a floor either above or below the current elevation. At step 430, the user may be prompted to specify any additional attributes of the desired 3D stair object that may be defined by CAD application 105 for the 3D stair object. For example, attributes such as what materials to use in building the real-world construction or additional features such as railings, colors, etc. may be specified. At step 435, once the user has specified the information requested as part of steps 410-430, the CAD application 105 generates the 3D stair object.

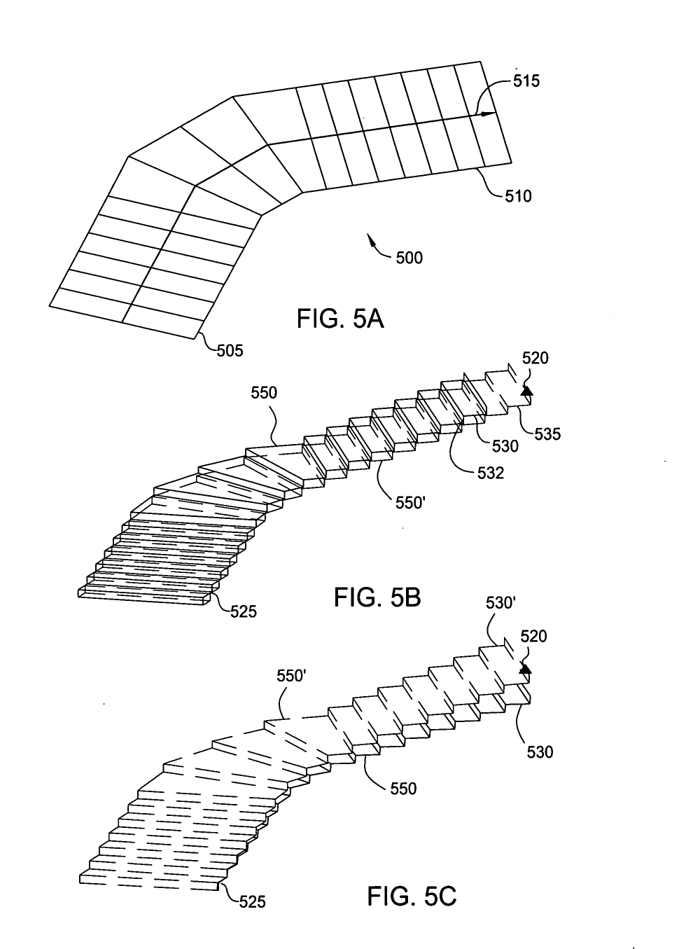

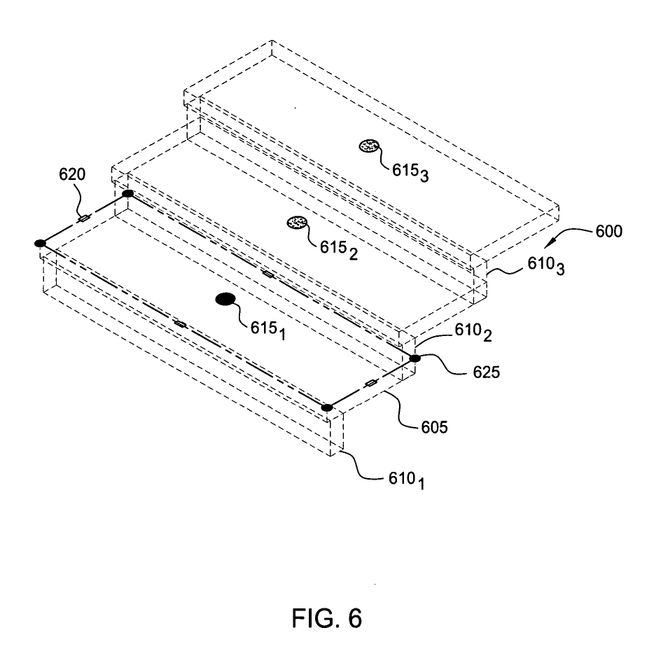

Once created, the GUI interface 110 may display a visual representation of the 3D stair object in CAD drawing 120. Additionally, stair editing tools 116 may be provided to allow the user to modify various aspects of the 3D stair object. Thus, the user may edit the 3D Stair object as a single entity, without having to edit each individual tread to modify properties related to the overall stair. In one embodiment, stair editing tools 116 may include tools for editing the height and length of the 3D stair object as a whole and may also include tools used to select and edit the geometry of an individual tread. For example, FIGS. 5A-5C illustrates the height and length of a 3D stair object being edited and FIG. 6 illustrates the geometry of an individual tread being edited.

First, FIG. 5A illustrates a selection of 2D line work 500 used to generate a 3D stair object, according to the method 400 of FIG. 4. As shown, 2D line work 500 includes a path 515 indicating the direction of a 3D stair object to be generated. 2D line work 500 also includes a plurality of closed tread profiles (a total of 17 tread profiles are shown). For simplicity, only a lower tread profile 505 and an upper tread profile 510 are numbered in FIG. 5A.

FIG. 5B shows a 3D stair object 550 generated from 2D line work 500. 3D stair object 550 includes a tread corresponding to each tread profile of 2D line work 500. For example, tread 525 corresponds to lower tread profile 505, and tread 530 corresponds to and upper tread profile 510. As shown, each riser runs parallel to the leading edge of the tread above that riser. For example, riser 532 runs parallel to the leading edge of tread 530. Stair object 550 also includes a grip 520. When the user selects 3D stair object 550, the GUI interface 110 may present grip 520 which, when selected, may provide a convenient mechanism for editing the height or length of the 3D stair object 550.

FIG. 5B shows the effect of a user interacting with grip 520 to modify the overall length of 3D stair object 350. By dragging the grip 520, a user may add (or remove) risers and tread profiles to modify the length of 3D stair object 550. For example, dashed lines of stair 550′ represent the result of dragging grip 520 in order to add two additional tread profiles to 3D stair object 350. In one embodiment, the tread nearest to grip point 520 is duplicated to increase the length of the stair object 550. Similarly, if grip object 520 is used to remove treads, then the tread nearest to grip point 520 is removed from stair object 550. At the same time, the height of the risers may be re-computed to maintain the overall stair height.

Alternatively, the length of 3D stair object 550 may be modified by directly changing the number of risers. In such an embodiment, the length of 3D stair object 550 is modified by changing a riser count property of the 3D stair object. For example, 3D stair object 550 includes 18 risers (one for each tread, and one additional riser to connect the top most tread to a landing). If the user changes the riser count to add or subtract treads from 3D stair object 550, then the height of the risers may be re-computed to maintain the same stair height for the desired number of risers. Typically, changes in height are evenly distributed across all of the risers in 3D stair object 550 and treads are added (or removed) based on either the first, or last, tread currently present in the stair.

FIG. 5C shows the effect of a user interacting with grip 520 to modify the overall height of 3D stair object 550. In one embodiment, the height of 3D stair object 550 may be modified using a height grip. When the user selects and drags the grip 520 in a vertical direction, the CAD application 105 re-calculates the the stair height by recalculating the height of the risers, leaving the treads unmodified. As shown in FIG. 5C, by dragging grip 520, the user is presented with a modified stair object 550′ (represented in FIG. 5C using dashed lines). By confirming the modification, modified 3D stair object 550′ will replace 3D stair object in CAD drawing 120. Alternatively, the user may edit the overall height of 3D stair object by changing the value of a height property associated with 3D stair object or by specifying a desired height to user for the risers in 3D stair object 550.

In addition to grip 520 used to modify the height or length of 3D stair object 550, additional grips may be provided to facilitate other modifications to the 3D stair object 550. For example a location grip may be provided that allows the user to move the entire 3D stair object 550 from one position in CAD drawing 120 to another. Another grip could include a path grip used to edit the shape of path 515.

In one embodiment, stair editing tools 116 may also include a command to cause GUI interface 110 to display a selectable grip positioned on each tread. For example, FIG. 6 illustrates a selection of treads from a 3D stair object 600 being manipulated using selectable grips, according to one embodiment of the invention. As shown, 3D stair object 600 includes three treads 605₁, 605₂, and 605₃ connected by risers 610₁, 610₂, and 610₃. Each tread 605 includes a tread selection grip 615. In one embodiment, selecting at a particular tread selection grip 615 activates edge and vertex grip for only the selected tread and only one tread or riser may be active for editing at any given time. In such a case, selecting another tread selection grip 615 will deactivate any active edge and vertex grips and activate edge and vertex grips for the selected tread. Once selected, the edge and vertex grips allow the user to edit the geometry of an individual tread, without distributing the geometry of 3D stair object 600 as a whole.

Illustratively, 3D stair object 600 shows tread 615, having been selected, and in response, edge grips 620 and vertex 625 have been activated. By selecting one of edge grips 620 or vertex 625 grips, the user may modify the geometry of the tread 6051. For example, by selecting edge grip 620, the length of tread 605₁ may be modified by dragging edge grip to a new location. Similarly, by selecting vertex grip 625, both the length and width of tread 605, may be modified.

In addition to modifications to the length and height of one of treads 605, the user may modify the geometry edges of a tread, for example, by selecting a straight edge of a tread and replacing it with a curved arc or freeform line. Also, other interface tools 116 may allow the user to modify the treads of 3D stair object 600 by selecting one tread and replacing it with another, duplicating one tread, or performing other manipulations. For example, to replace a tread, the GUI interface 110 may allow a user to select a source tread and then select multiple target treads to be replaced with the source tread. Other variations and combinations for editing a 3D stair object using user selected grips, or other elements of GUI interface 110 will be readily apparent to one of skill in the art.

As described herein, embodiments of the invention allow users to generate complex 3D stair objects from relatively simple inputs. For example, embodiments of the invention allow users to compose a CAD drawing 120 that includes irregularly shaped staircases, custom shaped treads, and combinations of these. Users provide a minimal set of 2D line work for the desired 3D stair object that includes a path of the desired 3D stair object and a plurality of tread profiles. From this information, the CAD application 105 generates 3D stair object. Once generated, the 3D stair object may be manipulated using a variety of user selectable grips or other GUI interface tools. Thus embodiments of the invention simplify both the design process and work required to create and modify a 3D stair objects included in a CAD drawing.

While the foregoing is directed to embodiments of the present invention, other and further embodiments of the invention may be devised without departing from the basic scope thereof, and the scope thereof is determined by the claims that follow.

What is claimed is:

1. A method for generating a representation of a three dimensional (3D) stair object in a computer aided design (CAD) drawing, the method comprising:
identifying a selection of two dimensional (2D) line work in the CAD drawing;
identifying a selection of attributes for the 3D stair object to be generated;
generating, from the selection of 2D line work and the selection of attributes for the 3D stair object, a geometry specifying the shape of the 3D stair object; and
displaying the representation of the 3D stair object in the CAD drawing.

2. The method of claim 1, wherein identifying the selection of 2D line work in the CAD drawing comprises identifying the selection of a path and a plurality of tread profiles, wherein each tread profile specifies the shape of an individual tread of the 3D stair object to be generated, and wherein each tread profile is positioned along the path to indicate the relative position of treads in the 3D stair object to be generated.

3. The method of claim 1, wherein the geometry of the 3D stair object is represented by a plurality of tread objects and riser objects, and wherein each tread object represents a step in the 3D stair object and each riser object separates adjacent treads from one another.

4. The method of claim 1, wherein the selection of attributes for the 3D stair object to be generated include at least a carriage type, a direction, a height, and a length of the 3D stair object to be generated.

5. The method of claim 4, wherein attributes for different 3D stair objects are encapsulated as a style.

6. The method of claim 1, wherein identifying a selection of 2D line work in the CAD drawing comprises receiving a user selection of 2D line work present in the CAD drawing.

7. The method of claim 1, wherein identifying a selection of 2D line work in the CAD drawing comprises a user creating the selection of 2D line work using drawing tools provided by the CAD application.

8. The method of claim 1, further comprising modifying geometry of the 3D stair object in response to user input.

9. The method of claim 8, wherein modifying the geometry of the 3D stair object comprises modifying a height, length or position of the 3D stair object.

10. The method of claim 8, wherein modifying the geometry of the 3D stair object comprises modifying the geometry of an individual tread generated for the 3D stair object.

11. A computer-readable medium storing instructions for generating a representation of a three dimensional (3D) stair object in a computer aided design (CAD) drawing, including instructions for performing the steps of:
identifying a selection of two dimensional (2D) line work in the CAD drawing;
identifying a selection of attributes for the 3D stair object to be generated;
generating, from the selection of 2D line work and the selection of attributes for the 3D stair object, the 3D object; and
displaying the representation of the 3D stair object in the CAD drawing.

12. The computer-readable medium of claim 11, wherein identifying the selection of 2D line work in the CAD drawing comprises identifying the selection of a path and a plurality of tread profiles, wherein each tread profile specifies the shape of an individual tread of the 3D stair object to be generated, and wherein each tread profile is positioned along the path to indicate the relative position of treads in the 3D stair object to be generated.

13. The computer-readable medium of claim 11, wherein the geometry of the 3D stair object is represented by a plurality of tread objects and riser objects, and wherein each tread object represents a step in the 3D stair object and each riser object separates adjacent treads from one another.

14. The computer-readable medium of claim 11, wherein the selection of attributes for the 3D stair object to be generated include at least a carriage type, a direction, a height, and a length of the 3D stair object to be generated.

15. The computer-readable medium of claim 14, wherein attributes for different 3D stair objects are encapsulated as a style.

16. The computer-readable medium of claim 11, wherein identifying a selection of 2D line work in the CAD drawing comprises receiving a user selection of 2D line work present in the CAD drawing.

17. The computer-readable medium of claim 11, wherein identifying a selection of 2D line work in the CAD drawing comprises a user creating the selection of 2D line work using drawing tools provided by the CAD application.

18. The computer-readable medium of claim 11, wherein the steps further comprise, modifying geometry of the 3D stair object in response to user input.

19. The computer-readable medium of claim 18, wherein modifying the geometry of the 3D stair object comprises modifying a height, a length or a position of the 3D stair object.

20. The computer-readable medium of claim 18, wherein modifying the geometry of the 3D stair object comprises modifying the geometry of an individual tread generated for the 3D stair object.

21. A computing device comprising:
a processor; and
a memory configured to store an application that includes instructions which, when executed by the processor, cause the processor to perform operations for generating a representation of a three dimensional (3D) stair object in a computer aided design (CAD) drawing, including the steps of:
identifying a selection of two dimensional (2D) line work in the CAD drawing;
identifying a selection of attributes for the 3D stair object to be generated;
generating, from the selection of 2D line work and the selection of attributes for the 3D stair object, a geometry specifying the shape of the 3D stair object; and
displaying the representation of the 3D stair object in the CAD drawing.

22. The computing device of claim 21, wherein identifying the selection of 2D line work in the CAD drawing comprises identifying the selection of a path and a plurality of tread profiles, wherein each tread profile specifies the shape of an individual tread of the 3D stair object to be generated, and wherein each tread profile is positioned along the path to indicate the relative position of treads in the 3D stair object to be generated.

23. The computing device of claim 21, wherein the geometry of the 3D stair object is represented by a plurality of tread objects and riser objects, and wherein each tread object represents a step in the 3D stair object and each riser object separates adjacent treads from one another.
